(19) United States
(12) Patent Application Publication
(10) Pub. No.: US 2007/0185240 A1
(43) Pub. Date: Aug. 9, 2007

(54) Inorganic-organic composite flame retardant composition

(75) Inventors: Gen Masuda, Chiba (JP); Toshifumi Hashiba, Chiba (JP); Kazutoshi Hayakawa, Chiba (JP); Nami Tsukamoto, Chiba (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., Tokyo (JP)

(21) Appl. No.: 10/583,410

(22) PCT Filed: Dec. 17, 2004
(86) PCT No.: PCT/JP04/18893

§ 371 Date: Jun. 20, 2006

(30) Foreign Application Priority Data
Dec. 22, 2003 (JP) 2003-424830

(51) Int. Cl. C08K 9/00; C09K 21/00

(52) U.S. Cl. 523/205; 524/437; 524/436; 252/601

(57) ABSTRACT

Disclosed is an inorganic-organic composite flame retardant composition which contains an inorganic hydroxide having a polymer layer and an organic resin. The polymer layer is formed through graft polymerization and has an average thickness of not less than 3 nm. When a shaped article is formed by using such a composition, the shaped article can have a sufficient flame retardance while being prevented from decrease in acid resistance, increase in dielectric constant or the like.

### TECHNICAL FIELD

The present invention relates to inorganic-organic composite flame retardant compositions.

### BACKGROUND ART

Flame retardant materials are widely used in such applications as electronic materials and building materials, and are generally prepared by mixing a flame retardant into a resin. Known flame retardants include halogenated compounds, antimony trioxide, phosphorus compounds and inorganic oxides (e.g., hydrated metal compounds).

The use of halogenated compounds and antimony trioxide has been restricted in recent years due to concerns over their effects on the environment, such as depletion of the ozone layer and the role they play in dioxin generation. The use of phosphorus compounds is generally avoided because their high unit cost tends to increase the cost of production.

Inorganic hydroxides, on the other hand, are regarded as being especially useful as flame retardants because they are free of such problems and also are relatively flameproof.

However, when an inorganic hydroxide is mixed into a base resin, for example, if the inorganic hydroxide is not sufficiently dispersible, a high loading of the inorganic hydroxide in the base resin is difficult to achieve, resulting in a less than satisfactory improvement in the target physical properties. It is thus very important to increase the affinity between the resin and the inorganic hydroxide, and to increase the dispersibility of the inorganic hydroxide in the base resin. Because inorganic hydroxides generally have a poor dispersibility in resins, when they must be used by admixture with a resin or the like, concomitant use is often made of a dispersant such as a surfactant or colloidal silica.

While improving the dispersibility of an inorganic hydroxide in a base resin by adding a dispersant is simple and convenient, the addition of a dispersant may lead to such problems as a rise in the dielectric constant and a decline in the heat resistance of shaped articles made from the ensuing composition.

Attempts have thus been made to enhance the dispersibility of inorganic hydroxides in resins by subjecting the inorganic hydroxide to surface modification. One such surface modification treatment of inorganic hydroxides in common use today involves coating the surface of an inorganic hydroxide with an organic compound.

In this method, the ability of the organic compound to adhere to the surface of the inorganic hydroxide is important. To increase such adhesion, use is made of a method in which a compound, such as a silane coupling agent, having functional groups capable of reacting with functional groups present on the surface of the inorganic hydroxide or functional groups introduced thereon by surface modification is employed to administer a strong coating by means of chemical bonding (see Patent Document 1: JP-A 61-275359, and Patent Document 2: JP-A 63-258958).

Yet, although a strong coating can easily be formed on the surface of the inorganic hydroxide by these prior-art methods, the resulting inorganic hydroxide lacks sufficient dispersibility in solvents and organic resins.

Efforts have thus been made recently to enhance the dispersibility of the inorganic hydroxide in solvents and resins by coating the surface of the inorganic hydroxide with a polymer layer (see Patent Document 3: JP-A 57-102959, Patent Document 4: JP-A 5-295294, and Patent Document 5: JP-A 5-295052).

However, owing to the low efficiency of graft polymerization and other reasons, the surface-treated inorganic hydroxides obtained by such methods lack a polymer layer of sufficient thickness on the surface thereof. Moreover, because the polymer layer is not thick enough, formation of the polymer layer on the surface fails to sufficiently suppress such characteristics inherent to the inorganic hydroxide as a high dielectric constant and a low acid resistance. As a result, while the improvement in dispersibility does enable high loadings to be achieved, new problems such as a decline in acid resistance and a rise in the dielectric constant have arisen in the resulting compositions and shaped articles obtained therefrom.

Patent Document 1: JP-A 61-275359

Patent Document 2: JP-A 63-258958

Patent Document 3: JP-A 57-102959

Patent Document 4: JP-A 5-295294

Patent Document 5: JP-A 5-295052

### DISCLOSURE OF THE INVENTION PROBLEMS TO BE SOLVED BY THE INVENTION

It is therefore an object of the present invention to provide an inorganic-organic composite flame retardant composition which includes both an inorganic hydroxide having a polymer layer and an organic resin, which can impart shaped articles made therefrom with a sufficient flame retardance, and which is capable of preventing a decrease in the acid resistance and a rise in the dielectric constant of such shaped articles.

### MEANS FOR SOLVING THE PROBLEMS

We have conducted extensive investigations in order to achieve the above objects. As a result, we have discovered that, in a composition which includes both an inorganic hydroxide having a polymer layer with an average thickness of at least 3 nm formed by graft polymerization and an organic resin, because the inorganic hydroxide has an excellent dispersibility and the coating thereon is sufficiently thick, high loadings of the inorganic hydroxide can be achieved, enabling the flame retardance to be greatly enhanced. Moreover, we have found that the decrease in acid resistance and the decline in physical characteristics, such as a rise in the dielectric constant, which occur in prior-art compositions prepared by the addition of an inorganic hydroxide to an organic resin or the like, and in shaped articles obtained from such compositions, can in this way be effectively suppressed.

Accordingly, the present invention provides the following inorganic-organic composite flame retardant compositions.

[1] An inorganic-organic composite flame retardant composition which includes an inorganic hydroxide or inorganic oxide having a polymer layer, and an organic resin; wherein the polymer layer is formed by graft polymerization and has an average thickness of at least 3 nm.

[2] The inorganic-organic composite flame retardant composition of [1] above having a percent weight loss, when acid-treated by 5 minutes of immersion in an aqueous solution containing 20 wt % of hydrogen chloride, which satisfies the following relationship with respect to the percent weight loss, when similarly acid treated, by an untreated inorganic hydroxide-containing composition that includes, instead of the inorganic hydroxide in the inorganic-organic composite flame retardant composition, a like amount (inorganic hydroxide basis) of an inorganic hydroxide lacking a polymer layer:
(percent weight loss of inorganic-organic composite flame retardant composition)/(percent weight loss of untreated inorganic hydroxide-containing composition)<0.50.
[3] The inorganic-organic composite flame retardant composition of [1] above which has a dielectric constant that satisfies the following relationship with respect to the dielectric constant of an untreated inorganic hydroxide-containing composition that includes, instead of the inorganic hydroxide in the inorganic-organic composite flame retardant composition, a like amount (inorganic hydroxide basis) of an inorganic hydroxide lacking a polymer layer:
(dielectric constant of inorganic-organic composite flame retardant composition)/(dielectric constant of untreated inorganic hydroxide-containing composition)<1.00.
[4] The inorganic-organic composite flame retardant composition of [1] above which has an elastic modulus that satisfies the following relationship with respect to the elastic modulus of an untreated inorganic hydroxide-containing composition that includes, instead of the inorganic hydroxide in the inorganic-organic composite flame retardant composition, a like amount (inorganic hydroxide basis) of an inorganic hydroxide lacking a polymer layer:
(elastic modulus of inorganic-organic composite flame retardant composition)/(elastic modulus of untreated inorganic hydroxide-containing composition)>1.10.
[5] The inorganic-organic composite flame retardant composition of any one of [1] to [4] above, wherein the inorganic hydroxide is in the form of particles having an average particle size of 1 nm to 100 μm.
[6] The inorganic-organic composite flame retardant composition of any one of [1] to [5] above, wherein the inorganic hydroxide is one or more selected from the group consisting of aluminum hydroxide, magnesium hydroxide, potassium hydroxide and calcium hydroxide.
[7] The inorganic-organic composite flame retardant composition of any one of [1] to [6] above, wherein the inorganic hydroxide is magnesium hydroxide and/or aluminum hydroxide, and the polymer layer is a layer composed of a styrene resin and/or an olefin resin.

### ADVANTAGEOUS EFFECTS OF THE INVENTION

Because the inorganic-organic composite flame retardant composition of the invention is made up of both an inorganic hydroxide or inorganic oxide having a polymer layer and an organic resin, and because the polymer layer is formed by graft polymerization and has an average thickness of at least 3 nm, the inorganic hydroxide can be dispersed within a matrix resin to a high concentration. This makes it possible to achieve a high loading of inorganic hydroxide and thus a considerable enhancement in the flame retardance, in addition to which it also enables more effective suppression of the decrease in acid resistance and the decline in physical qualities (e.g., a rise in the dielectric constant) that have occurred in prior-art compositions prepared by adding an inorganic hydroxide to an organic resin.

### BEST MODE FOR CARRYING OUT THE INVENTION

The invention is described more fully below.

Inorganic-organic composite flame retardant compositions according to the invention include an inorganic hydroxide having a polymer layer, and an organic resin. The polymer layer is formed by graft polymerization, and has an average thickness of at least 3 nm.

In the practice of the invention, illustrative, non-limiting, examples of the inorganic hydroxide include aluminum hydroxide, magnesium hydroxide, potassium hydroxide, calcium hydroxide, nickel hydroxide, chromium hydroxide, iron hydroxide, and copper hydroxide. The use of aluminum hydroxide, magnesium hydroxide, potassium hydroxide or calcium hydroxide is preferred from the standpoint of the versatility as a flame retardant and ready availability. When the polymer layer is composed of a polyolefin resin, the use of magnesium hydroxide and/or aluminum hydroxide as the inorganic particles is especially preferred.

The shape of the inorganic hydroxide will vary according to the intended use of the composition and therefore cannot be strictly specified. However, given that the improvement in the dispersibility of the inorganic hydroxide within the composition and the flame retardance improving effect are proportional to the specific surface area of the inorganic hydroxide (see Kobunshi no nannen-ka gijutsu [Polymer flame-retarding technology], published by CMC Shuppan), it is desirable for the inorganic hydroxide to be in the form of spherical or substantially spherical particles having an average size of 1 nm to 100 μm, preferably 50 nm to 50 μm, and more preferably 100 nm to 20 μm.

The average particle size is measured with a particle size analyzer (9320-X100, manufactured by Nikkiso Co., Ltd.).

The polymer making up the polymer layer is not subject to any particular limitation, provided it is a polymer that can be synthesized by graft polymerization. Illustrative examples include olefin polymers such as polyethylene and polypropylene; styrene polymers such as polystyrene; poly(meth)acrylic acid derivatives such as polymethyl acrylate, polyethyl acrylate, polymethyl methacrylate, polyethyl methacrylate, poly(meth)acrylate and polymethyl (meth)acrylate; vinyl carboxylates such as polyvinyl acetate, polyvinyl propionate, polyvinyl benzoate and polyvinyl butyrate; polyvinyl ethers such as polyvinyl methyl ether, polyvinyl ethyl ether and polyvinyl isobutyl ether; polyvinyl ketones such as polyvinyl methyl ketone, polyvinyl hexyl ketone and polymethyl isopropenyl ketone; poly(N-vinyl compounds) such as poly(N-vinylpyrrole), poly(N-vinylcarbazole), poly(N-vinylindole) and poly(N-vinylpyrrolidone); and poly(meth)acrylonitrile. These may be used singly or as combinations of two or more thereof. Use can also be made of one or more copolymer of the various monomers used in these polymers. Of the above, the use of polystyrene or a poly(meth)acrylic acid derivative is preferred on account of the ease of polymerizing the monomer.

It is also possible to use in the invention a polymer which forms a crosslinked structure at the surface of the inorganic hydroxide.

The polymer layer on the inorganic hydroxide has an average thickness of at least 3 nm. At a polymer layer thickness below 3 nm, dispersibility in the organic resin decreases, reducing the loading of the inorganic hydroxide. In addition, the acid resistance and elastic modulus of the composition decrease, and a decline in the physical qualities, such as a rise in the dielectric constant, occur.

In view of the above, the average thickness of the polymer layer is preferably at least 3.5 nm, and more preferably at least 4 nm.

The thickness of the polymer layer is a value calculated from the volume of the grafted polymer layer, the volume of the inorganic hydroxide and the total surface area per cubic centimeter (cm³) of the polymer grafted inorganic hydroxide, all of which were determined based on density measurements taken with a gas pycnometer (Accupyc 1330, manufactured by Shimadzu Corporation; in helium).

Because the thickness of the polymer layer is governed by two factors—the molecular weight and the grafting density, the molecular weight of the polymer making up the polymer layer itself varies according to the thickness of the polymer layer and the grafting density, and cannot be strictly specified. Nevertheless, the number-average molecular weight (Mn) is generally from 1,000 to 1,000,000, preferably from 2,500 to 950,000, more preferably from 5,000 to 500,000, and even more preferably from 10,000 to 300,000. The number-average molecular weight is a measured value obtained by gel filtration chromatography.

The polymer layer in the present invention is formed by graft polymerization. The process of forming the polymer layer by grafted chains is exemplified here by a method in which the grafted chains are prepared beforehand by polymerization, then are chemically bonded to the surface of the inorganic hydroxide, and a method in which graft polymerization is carried out on the surface of the inorganic hydroxide. Although either method may be used, the latter approach, which is less subject to adverse effects such as steric hindrance, is preferable for increasing the density of the grafted chains at the surface of the inorganic hydroxide.

Illustrative examples of the chemical bonds between the inorganic hydroxide and the grafted chains include covalent bonds, hydrogen bonds, and coordinate bonds.

Although the polymer layer can be formed based on functional groups on the inorganic hydroxide itself, it is preferable to first modify the surface of the inorganic hydroxide with reactive functional groups.

The reactive functional groups may be selected as appropriate for the polymer layer forming method. Illustrative examples include groups having polymerizable unsaturated bonds, such as α,β-unsaturated carbonyl groups, α,β-unsaturated nitrile groups, halogenated vinyl groups, halogenated vinylidene groups, aromatic vinyl groups, heterocyclic vinyl groups, conjugated dienes, and vinyl carboxylates; and carboxyl groups, carbonyl groups, epoxy groups, isocyanate groups, hydroxyl groups, amide groups, cyano groups, amino groups, epoxy groups, chloromethyl groups, glycidyl ether groups, lithio groups, ester groups, formyl groups, nitrile groups, nitro groups, carbodiimide groups and oxazoline groups.

Various known methods may be employed for modifying the inorganic hydroxide with these reactive functional groups, although a method involving treatment of the inorganic hydroxide with a surface treatment agent selected according to the functional group to be introduced onto the inorganic hydroxide is simple and thus preferable.

Illustrative, non-limiting examples of surface treatment agents include unsaturated fatty acids such as oleic acid; unsaturated fatty acid metal salts such as sodium oleate, calcium oleate and potassium oleate; unsaturated fatty acid esters; unsaturated fatty acid ethers; surfactants; silane coupling agents, including such alkoxysilanes as methacryloxymethyltrimethoxysilane, methacryloxypropyltrimethoxysilane, n-octadecylmethyldiethoxysilane, dodecyltrimethoxysilane, 2-(3,4-epoxycyclohexyl)ethyltrimethoxysilane, 2-(4-chlorosulfonyl)ethyltrimethoxysilane, triethoxysilane, vinyltrimethoxysilane and phenethyltrimethoxysilane; and titanate coupling agents.

Examples of graft polymerization reactions include addition polymerization reactions such as free-radical polymerization, ionic polymerization, oxidative anionic polymerization and ring-opening polymerization; polycondensation reactions such as elimination polymerization, dehydrogenation polymerization, and denitrogenation polymerization; hydrogen transfer polymerization reactions such as addition polymerization, isomerization polymerization, and group transfer polymerization; and addition condensation. Of these, free-radical polymerization is especially preferred because it is simple, very cost-effective, and is commonly used for the industrial synthesis of various polymers. Where there is a need to control the molecular weight of the grafted chains, the molecular weight distribution and the grafting density, use can be made of living radical polymerization.

Living radical polymerization is broadly divided into three types, any of which may be used in the present invention: (i) a dissociation-bonding mechanism in which polymerization proceeds by activation involving the use of typically heat or light to reversibly cleave the covalent bond on a dormant species P—X so that it dissociates to a P radical and an X radical; (ii) an atom transfer mechanism (atom transfer radical polymerization, or ATRP) in which polymerization proceeds by the activation of P—X under the action of a transition metal complex; and (iii) an exchange chain transfer mechanism in which polymerization proceeds by P—X triggering an exchange reaction with another radical.

The graft polymerizable monomers are not subject to any particular limitation, provided they are compounds having functional groups capable of reacting in graft polymerization.

For example, when a radical polymerization reaction is employed, use can be made of any one, or combination of two or more, of the following: styrene compounds such as styrene, o-methylstyrene, m-methylstyrene, p-methylstyrene, α-methylstyrene, p-ethylstyrene, 2,4-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene and 3,4-dichlorostyrene; (meth)acrylic acid derivatives such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate, stearyl methacrylate, (meth)acrylonitrile and (meth)acrylate; vinyl carboxylates such as vinyl acetate, vinyl propionate, vinyl benzoate and vinyl butyrate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; and compounds having fluoroalkyl groups, such as vinyl fluoride, vinylidene fluoride, tetrafluoroethylene, hexafluoropropylene, trifluoroethyl acrylate and tetrafluoropropyl acrylate. Of these, from the standpoint of monomer reactivity, the use of a vinyl group-based and/or (meth)acryl group-based monomer, copolymer or polymer is preferred.

When radical polymerization is employed, it is also possible to prepare a polymer having a crosslinked structure using a monomer with two or more reactive unsaturated bonds (double bonds). Examples of such monomers include aromatic divinyl compounds such as divinylbenzene and divinylnaphthalene; and compounds such as ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol triacrylate, pentaerythritol tetraacrylate, pentaerythritol dimethacrylate, pentaerythritol tetramethacrylate, glycerol acryloxy dimethacrylate, N,N-divinyl aniline, divinyl ether, divinyl sulfide and divinyl sulfone. These may be used singly or as combinations of two or more thereof. Of the above, the use of a vinyl group-based and/or a (meth)acryl group-based monomer or copolymer is preferred.

Any of various known polymerization initiators may be used when carrying out radical polymerization. Illustrative examples include benzoyl peroxide, cumene hydroperoxide, t-butyl hydroperoxide, persulfates such as sodium persulfate, potassium persulfate and ammonium persulfate; and azo compounds such as azobisisobutyronitrile, azobismethylbutyronitrile and azobisisovaleronitrile. These may be used singly or as combinations of any two or more thereof.

When a polymerization process other than free radical polymerization is employed, illustrative, non-limiting, examples of compounds which may be reacted with the reactive functional groups that have been introduced onto the surface of the inorganic hydroxide include carboxylic acids and carboxylic acid derivatives, such as formic acid, acetic acid, propionic acid, butyric acid, valeric acid, oxalic acid, malonic acid, succinic acid, glutaric acid, adipic acid, pimelic acid, maleic acid, fumaric acid, phthalic acid, isophthalic acid, terephthalic acid, acetyl chloride and benzoyl chloride; inorganic acids and inorganic bases such as sulfuric acid, phosphoric acid, sodium hydroxide and potassium hydroxide; alcohols such as methanol, ethanol, phenol, methylphenol, nitrophenol, picric acid, ethylene glycol and glycerol; halogenated organic compounds such as ethyl bromide, (S)-3-bromo-3-methylhexane and chloromethane; amine compounds such as ethylamine, aminoethane, 2-aminopentane, 3-aminobutanoic acid, aniline, p-bromoaniline, cyclohexylamine, ammonia, acetamide, p-toluidine and p-nitrotoluene; and formaldehyde. Use may also be made of copolymers or polymers composed of one or more of these compounds.

Solvents used in the polymerization reaction are not subject to any particular limitation, and may be suitably selected from among the various solvents used in polymer synthesis. Illustrative examples include water; alcohols such as methanol, ethanol, 1-propanol, 2-propanol, 1-butanol, 2-butanol, i-butyl alcohol, t-butyl alcohol, 1-pentanol, 2-pentanol, 3-pentanol, 2-methyl-1-butanol, i-pentyl alcohol, t-pentyl alcohol, 1-hexanol, 2-methyl-1-pentanol, 4-methyl-2-pentanol, 2-ethylbutanol, 1-heptanol, 2-heptanol, 3-heptanol, 2-octanol, 2-ethyl-1-hexanol, benzyl alcohol and cyclohexanol; ether alcohols such as methyl cellosolve, ethyl cellosolve, isopropyl cellosolve, butyl cellosolve and diethylene glycol monobutyl ether; ketones such as acetone, methyl ethyl ketone, methyl isobutyl ketone and cyclohexanone; esters such as ethyl acetate, butyl acetate, ethyl propionate and cellosolve acetate; aliphatic or aromatic hydrocarbons such as pentane, 2-methylbutane, heptane, n-hexane, 2-methylpentane, 2,2-dimethylbutane, 2,3-dimethylbutane, heptane, n-octane, isooctane, 2,2,3-trimethylpentane, nonane, decane, cyclopentane, methyl cyclopentane, cyclohexane, methyl cyclohexane, ethyl cyclohexane, p-menthane, dicyclohexyl, benzene, toluene, xylene, ethyl benzene and anisole (methoxybenzene); halogenated hydrocarbons such as carbon tetrachloride, trichloroethylene, chlorobenzene and tetrabromoethane; ethers such as diethyl ether, dimethyl ether, trioxane and tetrahydrofuran; acetals such as methylal and diethylacetal; aliphatic acids such as formic acid, acetic acid and propionic acid; and sulfur or nitrogen-bearing organic compounds such as nitropropane, nitrobenzene, dimethylamine, monoethanolamine, pyridine, dimethylformamide, dimethylsulfoxide and acetonitrile. Any one or combinations of two or more thereof may be used.

Of these solvents, the use of dimethylformamide, tetrahydrofuran or n-methyl-2-pyrrolidone, which have both oil solubility and water solubility, is preferred because these solvents have a good ability to disperse the inorganic hydroxide prior to treatment and also have a good ability to dissolve the polymerized graft polymer, enabling a high-molecular-weight grafted polymer to be polymerized.

The graft polymerization conditions are not subject to any particular limitation. Various known conditions may be employed according to such considerations as the monomer being used.

For example, when grafting is effected by carrying out free radical polymerization at the surface of the inorganic hydroxide, the amount of monomer having functional groups that can be reacted per 0.1 mol of reactive functional groups introduced onto the inorganic hydroxide is from 1 to 300 mol, and the amount of polymerization initiator is generally from 0.005 to 30 mol. The polymerization temperature is generally from −20 to 1,000° C., and the polymerization time is generally from 0.2 to 72 hours.

When graft polymerization is carried out, various additives such as dispersants, stabilizers and emulsifying agents (surfactants) may be optionally added to the polymerization reaction system.

The polymer layer formed by graft polymerization, aside from being obtained by grafting at the surface of the inorganic hydroxide in the manner just described, may alternatively be obtained, as noted above, by reacting an already prepared polymer with reactive functional groups on the surface of the inorganic hydroxide.

Illustrative, non-limiting, examples of methods that may be used to react the inorganic hydroxide with the polymer in such a case include a dehydration reaction, a nucleophilic substitution reaction, an electrophilic substitution reaction, an electrophilic addition reaction, and an adsorption reaction.

Illustrative, non-limiting, examples of the organic resin in the inorganic-organic flame retardant composition of the invention include thermoplastic resins such as olefin polymers (e.g., polyethylene, polypropylene), styrene polymers (e.g., polystyrene), poly(meth)acrylic acid derivatives (e.g., polymethyl methacrylate, polyethyl acrylate, polymethyl methacrylate, polyethyl methacrylate, poly(meth)acrylate), vinyl carboxylates (e.g., polyvinyl acetate, polyvinyl propionate, polyvinyl benzoate, polyvinyl butyrate), polyvinyl ethers (e.g., polyvinyl methyl ether, polyvinyl ethyl ether, polyvinyl isobutyl ether), polyvinyl ketones (e.g., polyvinyl methyl ketone, polyvinyl hexyl ketone, polymethyl isopropenyl ketone), poly(N-vinyl compounds) (e.g., poly(N-vinylpyrrole), poly(N-vinylcarbazole), poly(N-vinylindole), poly(N-vinylpyrrolidone)), polyethylene, fluoropolymers, polyamides (e.g., nylon 6), polyesters, polycarbonate, silicone, polyacetal, acetyl cellulose, and poly(meth)acrylonitrile; and thermoset resins such as epoxy resins, phenol resins, urea resins, melamine resins, alkyd resins, and unsaturated polyester resins.

Of these, from the standpoint of such considerations as environmental compatibility and the diversity of uses for the composition, it is preferable to use polystyrene resins, polyolefin resins, poly(meth)acrylic resins, vinyl carboxylates such as vinyl acetate, epoxy resins, and polyester resins.

In addition, to increase the dispersibility in and affinity to the organic resin by the inorganic hydroxide, and to suppress a decline in the mechanical strength of shaped articles fabricated from compositions containing these components, it is preferable for the polymer layer at the surface of the inorganic hydroxide to be the same type of polymer as the organic resin. The combination of the polymer layer and the organic resin is preferably a combination of a polymer layer with an organic resin, each being selected from among, for example, polystyrene resins, polyolefin resins, poly(meth)acrylic resins, vinyl carboxylates such as vinyl acetate, polyester resins, and epoxy resins.

No particular limitation is imposed on the compounding ratio between the polymer layer-bearing inorganic hydroxide and the organic resin. However, to achieve a good balance between the flame retardance enhancing effect and the decrease in physical properties owing to incorporation of the inorganic hydroxide, the weight ratio of the polymer layer-bearing inorganic hydroxide (untreated inorganic hydroxide basis) to the organic resin is preferably from 5:95 to 90:10, more preferably from 10:90 to 80:20, and even more preferably from 30:70 to 70:30.

In addition, it is preferable for the inorganic-organic composite flame retardant composition of the invention to have at least one of characteristics (1) to (3) below. In (1) to (3) below, the organic resin in both compositions is of course the same. Also, the term ‘composition’ as used in the present invention, encompasses not only compositions of indefinite shape obtained by merely mixing the inorganic hydroxide and the organic resin, but also shaped materials obtained by shaping such compositions.

(1) The inorganic-organic composite flame retardant composition has a percent weight loss, when acid-treated by 5 minutes of immersion in an aqueous solution containing 20 wt % of hydrogen chloride, which satisfies the following relationship with respect to the percent weight loss, when similarly acid treated, by an untreated inorganic hydroxide-containing composition that includes, instead of the polymer layer-bearing inorganic hydroxide in the inorganic-organic composite flame retardant composition, a like amount (inorganic hydroxide basis) of an inorganic hydroxide lacking a polymer layer: (percent weight loss of inorganic-organic composite flame retardant composition)/(percent weight loss of untreated inorganic hydroxide-containing composition)<0.50, preferably <0.40, and more preferably <0.30.

If this percent weight loss ratio is 0.50 or more, the inorganic-organic composite flame retardant composition is very likely to have a poor acid resistance, which may make it impossible to use the composition in electrical materials that require acid treatment, or may otherwise limit its applications.

Aside from the size of the test specimen, the hydrochloric acid concentration and the duration of the test, the above test method is carried out in accordance with the test method described in JIS K7114. The percent weight loss is determined based on the weight of the composition following acid treatment, thorough washing with water, and drying.

(2) The inorganic-organic composite flame retardant composition has a dielectric constant which satisfies the following relationship with respect to the dielectric constant of an untreated inorganic hydroxide-containing composition that includes, instead of the polymer layer-bearing inorganic hydroxide in the inorganic-organic composite flame retardant composition, a like amount (inorganic hydroxide basis) of an inorganic hydroxide lacking a polymer layer: (dielectric constant of inorganic-organic composite flame retardant composition)/(dielectric constant of untreated inorganic hydroxide-containing composition)<1.00, preferably <0.99, and more preferably <0.98.

If this dielectric constant ratio is 1.00 or more, the polymer layer formed on the surface of the inorganic hydroxide will have an insufficient dielectric constant increase preventing effect, which may limit use of the composition in the same way as mentioned above.

The dielectric constant is measured at a frequency of 1 GHz using a dielectric constant measuring instrument (4291B Impedance Material Analyzer, manufactured by Agilent Technologies).

(3) The inorganic-organic composite flame retardant composition has an elastic modulus which satisfies the following relationship with respect to the elastic modulus of an untreated inorganic hydroxide-containing composition that includes, instead of the polymer layer-bearing inorganic hydroxide in the inorganic-organic composite flame retardant composition, a like amount (inorganic hydroxide basis) of an inorganic hydroxide lacking a polymer layer: (elastic modulus of inorganic-organic composite flame retardant composition)/(elastic modulus of untreated inorganic hydroxide-containing composition)>1.10, and preferably >1.12.

An elastic modulus ratio of 1.10 or less, presumably as a result of insufficient dispersibility of the inorganic hydroxide in the organic resin, may weaken the mechanical strength of a shaped material obtained by shaping the composition, and most likely will limit the uses of the composition.

The elastic modulus is measured at room temperature using a thermal analysis/rheology system (EXTAR 600, manufactured by Seiko Instrument).

The inorganic-organic composite flame retardant compositions of the invention are able to suppress the declines in physical qualities (electrical characteristics (increased dielectric constant), mechanical characteristics (reduced elastic modulus)) and the decline in acid resistance associated with prior-art inorganic-organic composite type compositions. Moreover, because of the high affinity between the polymer layer-bearing inorganic hydroxide and the organic resin, uniform loading of the inorganic hydroxide in the organic resin can be achieved without the addition of a surfactant or other dispersant. As a result, high loadings of the inorganic hydroxide are possible, and a new functionality which combines the distinctive characteristics of both the inorganic compound and the organic compound can be effectively achieved.

This inorganic-organic composite flame retardant composition also varies according to the type of inorganic hydroxide, polymer layer and organic resin, and is not subject to any particular limitation. For example, it can be advantageously used as materials requiring flame retardance in such areas as electronics materials, building materials, and automotive materials.

### EXAMPLES

The invention is illustrated more fully through the following synthesis examples, examples of the invention, and comparative examples. It should be noted, however, that the examples of the invention provided below are not intended to limit the invention.

[Examples of the Synthesis of Polymer Layer-Bearing Inorganic Hydroxide Particles]

### Synthesis Example 1

First, 20.0 g of Mg(OH)₂ having an average particle size of 700 nm (Kisuma 5Q, surface untreated Mg(OH)₂ prepared by Kyowa Chemical Industry Co., Ltd.) was thoroughly dispersed in 30.0 g of dimethylformamide (abbreviated below as “DMF”; available from Aldrich Japan) within a 100 mL round-bottomed flask. Next, 0.1 g of 3-methacryloxypropyltrimethoxysilane (a silane coupling agent produced by Chisso Corporation) was added and the flask contents were stirred for 30 minutes at 70° C. Next, 0.08 g of azobisisobutyronitrile (abbreviated below as “AIBN”; produced by Kanto Chemical Co., Inc.) and 30.0 g of styrene (Kanto Chemical) were added, and the mixture was heated at 70° C. for about 15 hours to effect the reaction.

Following reaction completion, to remove unreacted monomer and ungrafted polymer, the Mg(OH)₂ particles were washed with tetrahydrofuran (abbreviated below as “THF”; Wako Pure Chemical Industries, Ltd.) and suction filtered four times. After washing, the infrared spectrum of the particles was measured with an FT-IR8900 spectrometer (Shimadzu Corporation), whereupon absorption attributable to benzene rings was observed near 700 cm⁻¹, confirming that the particles had been styrene grafted.

The average particle size indicated above is a value that was measured using a particle size analyzer (MICROTRACHRA9320-X100, manufactured by Nikkiso Co., Ltd.).

### Synthesis Example 2

Aside from setting the amount of styrene at 8.0 g, polymer grafted Mg(OH)₂ was prepared in the same way as in Synthesis Example 1. Following reaction completion, grafting of the styrene was confirmed in the same way as in Synthesis Example 1.

### Synthesis Example 3

Aside from setting the reaction time to about one hour and a half and setting the amount of styrene to 8.0 g, polymer grafted Mg(OH)₂ was prepared in the same way as in Synthesis Example 1. Following reaction completion, grafting of the styrene was confirmed in the same way as in Synthesis Example 1.

### Synthesis Example 4

First, 20.0 g of Mg(OH)₂ having an average particle size of 700 nm (Kisuma 5Q) was thoroughly dispersed in 30.0 g of DMF within a 100 mL round-bottomed flask. Next, 0.08 g of AIBN and 30.0 g of styrene were added, and the mixture was heated at 70° C. for about 15 hours to effect the reaction.

Following reaction completion, the Mg(OH)₂ particles were recovered by suction filtration of the reaction mixture. The resulting Mg(OH)₂ particles were dried and the IR spectrum was measured with an FT-IR8900 spectrometer (Shimadzu Corporation), whereupon absorption attributable to benzene rings was observed near 700 cm⁻¹. This confirmed that the surface of the particles was coated with polystyrene.

Next, the recovered MG(OH)₂ particles were washed four times with THF in the same way as in Synthesis Examples 1 to 3. After washing, the IR spectrum of these particles was again measured with an FT-IR8900 spectrometer (Shimadzu Corporation), whereupon absorption attributable to benzene rings was not observed near 700 cm⁻¹. Hence, styrene had not been grafted onto the Mg(OH)₂ particles, confirming that the styrene was removed from the particle surfaces by washing.

The method described below was used to cleave the ester groups linking the grafted polymer to the Mg(OH)₂ in the polymer grafted Mg(OH)₂ particles obtained in Synthesis Examples 1 to 3, and the molecular weight and molecular weight distribution of the grafted polymer were measured.

The grafted Mg(OH)₂ particles obtained in these respective synthesis examples were dispersed in a mixed solution composed of 2 mL of distilled water, 12 mL of THF and 5 mL of ethanol (Kanto Chemical) within a 100 mL beaker, after which 0.22 g of potassium hydroxide (available from Sigma-Aldrich Japan) was added and the reaction was carried out at 55° C. for 7 hours.

Following the reaction, the reaction mixture was neutralized with concentrated hydrochloric acid (Wako Pure Chemical Industries, Ltd.), and the Mg(OH)₂ particles were removed. The solution remaining after removal of the particles was then concentrated, and the solid matter (grafted polymer) thus obtained was washed with water, hexane (Wako Pure Chemical Industries), and methanol (Wako Pure Chemical Industries).

The molecular weight of the washed grafted polymer was measured by gel filtration chromatography (GPC) using the following apparatus and conditions.

For the Mg(OH)₂ particles obtained in Synthesis Example 4, the THF solution after washing was concentrated with an evaporator, and the molecular weight was measured by gel filtration chromatography (GPC) using the following apparatus and conditions. The results of the number-average molecular weight (Mn) and weight-average molecular weight (Mw) measurements are shown in Table 1.

Molecular Weight Measurement Conditions

GPC apparatus: C-R7A, manufactured by Shimadzu Corporation
Detector: UV spectrophotometer detector (SPD-6A), manufactured by Shimadzu Corporation
Pump: Molecular weight distribution measurement system pump (LC-6AD), manufactured by Shimadzu Corporation
Columns: A total of three columns connected in series; two Shodex KF804L (Showa Denko K.K.) columns and one Shodex KF806 (Showa Denko)
Solvent: Tetrahydrofuran
Measurement temperature: 40° C.

The thickness of the polymer layer on the surface of the Mg(OH)₂ particles obtained in Synthesis Examples 1 to 4 was determined in the manner described below. The thickness of the organic layer on the Mg(OH)₂ particles (Kisuma 5A, produced by Kyowa Chemical Industry Co., Ltd.) surface treated with an organic material that are used in the subsequently described examples of the invention was also determined. Those results as well are shown in Table 1.

[Method of Measuring Thickness of Polymer Layer]

The densities of the respective Mg(OH)₂ particles obtained in Synthesis Examples 1 to 4 were determined using a gas pycnometer (Accupyc 1330, manufactured by Shimadzu Corporation; in helium). Based on these results and the density of the Mg(OH)₂ prior to grafting, the volume of the polymer layer, the volume of the inorganic hydroxide and the total surface area per cubic centimeter (cm³) of the polymer grafted inorganic hydroxide were determined. The thickness of the polymer layer was calculated from these values. The volume and total surface area were determined by assuming the Mg(OH)₂ at this time to be truly spherical.

TABLE 1

| (nm) | Mn | Mw | Thickness |
|---|---|---|---|
| Synthesis Example 1 | 20,000 | 95,000 | 6.0 |
| Synthesis Example 2 | 17,000 | 30,000 | 4.1 |
| Synthesis Example 3 | 2,000 | 5,500 | 1.5 |
| Synthesis Example 4 | 21,000 | 96,000 | 0* |
| Kisuma 5A | — | — | 0* |

Note:
In Table 1, “0*” signifies that, based on calculations, the thickness is substantially 0 nm.

[1] Preparation of Inorganic-Organic Composite Flame Retardant Compositions (Shaped Articles)

### Examples 1 and 2, and Comparative Examples 1 to 5

In the respective examples, a dispersion prepared by dispersing 4.61 g of the Mg(OH)₂ particles that were polymer grafted in Synthesis Example 1 (Example 1), 4.56 g of the Mg(OH)₂ particles that were polymer grafted in Synthesis Example 2 (Example 2), 4.55 g of the Mg(OH)₂ particles that were polymer grafted in Synthesis Example 3 (Comparative Example 3), 4.80 g of the Mg(OH)₂ particles before THF washing obtained in Synthesis Example 4 (Comparative Example 4), 4.50 g of the Mg(OH)₂ particles after THF washing obtained in Synthesis Example 4 (Comparative Example 5), 4.50 g of commercial surface-treated Mg(OH)₂ (Kisuma 5A, produced by Kyowa Chemical Industry) (Comparative Example 1), or 4.50 g of commercial untreated Mg(OH)₂ (Kisuma 5Q, produced by Kyowa Chemical Industry) (Comparative Example 2) in 4 g of THF was added to a mixture composed of 3.60 g of epoxy resin (Epiclon N-740, produced by Dainippon Ink & Chemicals, Inc.) and 0.90 g of a curing agent (Novacure HX3722, produced by Asahi Kasei Corporation), thereby giving an inorganic-organic composite flame retardant composition.

Here, the amount of Mg(OH)₂ added in the respective examples of the invention and comparative examples was set, using the method of calculation indicated below, in such a way that the amount of virgin Mg(OH)₂ included in the composition was the same in each case.

Method of Calculation

The densities of 5 g of, respectively, the polymer grafted Mg(OH)₂ prepared in Synthesis Example 2, Kisuma 5A, and Kisuma 5Q were measured with a gas pycnometer (Accupyc 1330, manufactured by Shimadzu Corporation; in helium). The results were 2.39 g/cm³ for both Kisuma 5A and Kisuma 5Q, and 2.35 g/cm³ for the polymer-grafted Mg(OH)₂ prepared in Synthesis Example 2.

Here, because styrene has a density of 1.07 g/cm³ and untreated Mg(OH)₂ (Kisuma 5Q) has a density of 2.39 g/cm³, letting the polystyrene grafted volume per cubic centimeter be X cm³, we get the following:
1.07X+2.39(1−X)=2.35.
Thus, X is 0.030 cm³.

Therefore, the weight of grafted polystyrene per cubic centimeter is 0.030 cm³×1.07 g/cm³=0.032 g, and the weight of the Kisuma 5Q is (1-0.030) cm³×2.39 g/cm³=2.31 g.

Hence, the amount of grafted polymer on the above polymer-grafted Mg(OH)₂ as a proportion of the total is given by
100×0.032 g/2.31 g=1.3 wt %.

From the above, the amounts of Mg(OH)₂ present in 4.50 g of Kisuma 5A, in 4.50 g of Kisuma 5Q, and in 4.56 g of the polymer grafted Mg(OH)₂ prepared in Synthesis Example 2 are equivalent.

The amounts of grafted polymer on the polymer-grafted Mg(OH)₂ particles obtained in Synthesis Examples 1, 3 and 4 were also determined in the same way.

The inorganic-organic composite flame retardant compositions prepared in each of the above examples of the invention and comparative examples were formed into films by bar coating. The resulting films were dried overnight, then cured by 1 hour of heat treatment at 100° C. followed by 0.5 hour of heat treatment at 150° C. The following properties of the resulting cured film were evaluated. The results are shown in Tables 2 and 3. The cured films all had a thickness of about 150 μm.

[Evaluating the Formability and Physical Properties of the Composition (Shaped Article)]

(1) Formability Test

Aside from setting the dimensions of the test specimens to a length of 10 cm, a width of 5 cm, and a thickness of about 150 μm, the cured film was evaluated based on the following criteria in accordance with the method described in JIS K 7104.
Good: The Mg(OH)₂ was very uniformly loaded, and the cured film had a smooth surface (as determined by touch and sight).
Fair: The Mg(OH)₂ was uniformly loaded, but the surface of the cured film was uneven in places.
NG: The Mg(OH)₂ was not uniformly loaded, and the entire surface of the cured film was uneven.
   (2) Mechanical Strength Test

The elastic modulus of the cured film was measured at room temperature using a thermal diffraction/rheology system (EXTAR600; Seiko Instrument).
Exc: The elastic modulus improved substantially over that in Comparative Example 2.
Good: The elastic modulus improved over that in Comparative Example 2.
Fair: The elastic modulus improved slightly over that in Comparative Example 2.
   (3) Dielectric Constant Test

The dielectric constant of the cured film was measured at room temperature and a frequency of 1 GHz using a dielectric constant measuring instrument (4291B Impedance Material Analyzer, manufactured by Agilent Technologies). The untreated Mg(OH)₂ composition had a poor formability and a variable dielectric constant. Hence, the average of the values at four places was used.
Good: The dielectric constant was significantly lower than in Comparative Example 2.
Fair: The dielectric constant was slightly lower than in Comparative Example 2.
   (4) Evaluation of Acid Resistance

A cured film having a length of 10 cm, a width of 5 cm, and a thickness of about 150 μm was immersed for 5 minutes, one hour or 3 hours in an aqueous solution containing 20 wt % of hydrogen chloride (Wako Pure Chemical Industries), washed with distilled water, then dried and the weight following immersion for the respective lengths of time were measured.

The acid resistance was evaluated by calculating the percent weight loss from the weight before acid treatment and the weight after acid treatment, and was based also on the change in color of the cured film following acid treatment.
Good: The film was acid resistant

NG: The film lacked acid resistance

TABLE 2

| | | Elastic modulus | | | Dielectric constant | | |
|---|---|---|---|---|---|---|---|
| | | Measured | Elastic | | | Dielectric | |
| | | value | modulus | | Measured | constant | |
| | Formability | (10⁹ Pa) | ratio | Rating | value | ratio | Rating |
| Example 1 | Exc | 2.0 | 1.25 | Exc | 4.45 | 0.982 | Good |
| Example 2 | Exc | 1.8 | 1.13 | Good | 4.48 | 0.989 | Fair |
| Comparative | Fair | 1.7 | 1.06 | Fair | 4.50 | 0.993 | NG |
| Example 1 | | | | | | | |
| Comparative | NG | 1.6 | — | NG | 4.53 | — | NG |
| Example 2 | | | | | | | |
| Comparative | Fair | 1.7 | 1.06 | Fair | 4.50 | 0.993 | NG |
| Example 3 | | | | | | | |
| Comparative | NG | 1.6 | 1 | NG | 4.53 | 1 | NG |
| Example 4 | | | | | | | |
| Comparative | NG | 1.6 | 1 | NG | 4.50 | 0.993 | NG |
| Example 5 | | | | | | | |

TABLE 3

| | Acid resistance | | | | | | | | | |
|---|---|---|---|---|---|---|---|---|---|---|
| | 5 minutes | | | 1 hour | | | 3 hours | | | |
| | Percent | | Weight | Percent | | Weight | Percent | | Weight | |
| | weight | Color | loss | weight | Color | loss | weight | Color | loss | |
| | loss | change | ratio | loss | change | ratio | loss | change | ratio | Rating |
| Example 1 | 4 | substantially | 0.21 | 13 | slight | 0.29 | 25 | slight | 0.53 | Good |
| | | unchanged | | | whitening | | | whitening | | |
| Example 2 | 4 | substantially | 0.21 | 14 | slight | 0.32 | 26 | slight | 0.55 | Good |
| | | unchanged | | | whitening | | | whitening | | |
| Comparative | 12 | slight | 0.63 | 40 | white | 0.90 | 45 | white | 0.96 | NG |
| Example 1 | | whitening | | | color | | | color | | |
| | | | | | change | | | change | | |
| Comparative | 19 | slight | — | 44 | white | — | 47 | white | — | NG |
| Example 2 | | whitening | | | color | | | color | | |
| | | | | | change | | | change | | |
| Comparative | 10 | slight | 0.52 | 39 | white | 0.89 | 43 | white | 0.98 | NG |
| Example 3 | | whitening | | | color | | | color | | |
| | | | | | change | | | change | | |
| Comparative | 19 | slight | 1 | 44 | white | 1 | 47 | white | 1 | NG |
| Example 4 | | whitening | | | color | | | color | | |
| | | | | | change | | | change | | |
| Comparative | 19 | slight | 1 | 44 | white | 1 | 47 | white | 1 | NG |
| Example 5 | | whitening | | | color | | | color | | |
| | | | | | change | | | change | | |

In above Tables 2 and 3, the ratios of the various physical property values were calculated relative to the data for Comparative Example 2 (untreated Mg(OH)₂: Kisuma 5Q); that is, with the Comparative Example 2 data serving as the denominator.

[2] Flame Retardance Test

### Examples 3 and 4, and Comparative Examples 6 to 10

Aside from using the polymer-grafted Mg(OH)₂ particles prepared in Synthesis Example 1 (Example 3), the polymer-grafted Mg(OH)₂ particles prepared in Synthesis Example 2 (Example 4), the polymer-grafted Mg(OH)₂ particles prepared in Synthesis Example 3 (Comparative Example 8), the Mg(OH)₂ particles before THF washing obtained in Synthesis Example 4 (Comparative Example 9), the Mg(OH)₂ particles after THF washing obtained in Synthesis Example 4 (Comparative Example 10), untreated Mg(OH)₂ (Kisuma 5A, produced by Kyowa Chemical Industry) (Comparative Example 6), and untreated Mg(OH)₂ (Kisuma 5Q, produced by Kyowa Chemical Industry) (Comparative Example 7) so that the calculated amount of Mg(OH)₂ in each case is 8.3 g, inorganic-organic composite flame retardant compositions were prepared in the same way as in Example 1.

Cured films having a thickness of above 150 μm were fabricated from each of the resulting inorganic-organic composite flame retardant compositions in the same way as described above, then a flame retardance test was carried out by the method described below and the flame retardance in each case was evaluated. The results are shown in Table 4.

[Flame Retardance Test and Evaluation]

Apart from the thickness of the test specimen, a flammability test was carried out based on the UL 94 vertical flame retardance test method (flammability specifications for plastic materials). The results were rated according to the following three criteria: 94-V0 equivalent, 94-V1 equivalent, and 94-V2 equivalent.
Excellent: 94-V0 equivalent
Good: 94-V1 equivalent
Fair: 94-V2 equivalent

NG: Flammable

TABLE 4

Flammability test

| | Criteria | Rating |
|---|---|---|
| Example 3 | 94-V0 | Excellent |
| Example 4 | 94-V0 | Excellent |
| Comparative Example 6 | Flammable | Good |
| Comparative Example 7 | Flammable | Fair |
| Comparative Example 8 | Flammable | Good |
| Comparative Example 9 | Flammable | Fair |
| Comparative Example 10 | Flammable | Fair |

It is apparent from the results in Tables 2 to 4 that the inorganic-organic composite flame retardant compositions in the respective examples of the invention, which include the Mg(OH)₂ particles bearing a grafted polymer layer having a thickness of at least 3 nm that were obtained in above Synthesis Examples 1 and 2, all had an excellent formability and excellent physical properties. In the flame retardance test, due to the uniform loading of Mg(OH)₂, these inorganic-organic composite flame retardant compositions exhibited very high flame retardant effects.

By contrast, it is apparent from the results obtained in each of the comparative examples that, in compositions containing Mg(OH)₂ particles on which a polymer layer of a certain thickness has not been grafted to the inorganic hydroxide, an improvement in the formability and physical properties was not achieved.

From the above results, an inorganic hydroxide having a grafted polymer layer of at least 3 nm has a high dispersibility. In addition, when mixed into a resin, a decrease in the physical properties can be suppressed. Accordingly, it is possible, while preventing a decrease in the physical properties, to fully exhibit a flame retardance enhancing effect. It is anticipated that, owing to their high flame retardance, the inorganic-organic composite flame retardant compositions of the invention will see use in a variety of applications.

1. An inorganic-organic composite flame retardant composition comprising an inorganic hydroxide having a polymer layer, and an organic resin;
which is characterized in that the polymer layer is formed by graft polymerization and has an average thickness of at least 3 nm.

2. The inorganic-organic composite flame retardant composition of claim 1 which is characterized by having a percent weight loss, when acid-treated by 5 minutes of immersion in an aqueous solution containing 20 wt % of hydrogen chloride, which satisfies the following relationship with respect to the percent weight loss, when similarly acid treated, by an untreated inorganic hydroxide-containing composition that includes, instead of the inorganic hydroxide in said inorganic-organic composite flame retardant composition, a like amount (inorganic hydroxide basis) of an inorganic hydroxide lacking a polymer layer:
(percent weight loss of inorganic-organic composite flame retardant composition)/(percent weight loss of untreated inorganic hydroxide-containing composition)<0.50.

3. The inorganic-organic composite flame retardant composition of claim 1 which is characterized by having a dielectric constant which satisfies the following relationship with respect to the dielectric constant of an untreated inorganic hydroxide-containing composition that includes, instead of the inorganic hydroxide in said inorganic-organic composite flame retardant composition, a like amount (inorganic hydroxide basis) of an inorganic hydroxide lacking a polymer layer:
(dielectric constant of inorganic-organic composite flame retardant composition)/(dielectric constant of untreated inorganic hydroxide-containing composition)<1.00.

4. The inorganic-organic composite flame retardant composition of claim 1 which is characterized by having an elastic modulus which satisfies the following relationship with respect to the elastic modulus of an untreated inorganic hydroxide-containing composition that includes, instead of the inorganic hydroxide in said inorganic-organic composite flame retardant composition, a like amount (inorganic hydroxide basis) of an inorganic hydroxide lacking a polymer layer:
(elastic modulus of inorganic-organic composite flame retardant composition)/(elastic modulus of untreated inorganic hydroxide-containing composition)>1.10.

5. The inorganic-organic composite flame retardant composition of any one of claims 1 to 4, which is characterized in that the inorganic hydroxide is in the form of particles having an average particle size of 1 nm to 100 μm.

6. The inorganic-organic composite flame retardant composition of any one of claims 1 to 4, which is characterized in that the inorganic hydroxide is one or more selected from the group consisting of aluminum hydroxide, magnesium hydroxide, potassium hydroxide and calcium hydroxide.

7. The inorganic-organic composite flame retardant composition of any one of claims 1 to 4, which is characterized in that the inorganic hydroxide is magnesium hydroxide and/or aluminum hydroxide, and the polymer layer is a layer composed of a styrene resin and/or an olefin resin.
